(19) United States
(12) Patent Application Publication
(10) Pub. No.: US 2021/0101466 A1
(43) Pub. Date: Apr. 8, 2021

(54) Method of applying a engageable mechanism for supplying both intermittent impulses and smooth rotary motion as needed so that they may be applied within a vehicle's powertrain and a System for managing a Rotary Impact Powertrain in a vehicle and an apparatus for supplying both intermittent impulses and smooth rotary motion as needed so that they may be applied within a vehicle's powertrain

(71) Applicant: Dwight Darwin Alexander, Lewisburg, PA (US)

(72) Inventor: Dwight Darwin Alexander, Lewisburg, PA (US)

(21) Appl. No.: 16/592,768

(22) Filed: Oct. 4, 2019

(51) Int. Cl. B60K 6/10; F16D 5/00; F16H 25/12; F16D 25/00

(52) U.S. Cl. CPC B60K 6/10; F16D 5/00; F16D 2121/04; F16D 25/00; F16H 25/125

(57) ABSTRACT

The present invention relates to a power means and method for supplying both intermittent impulses and smooth rotary motion as needed so that they may be applied within a vehicle's powertrain in a most practical manner in order to overcome the vehicles path work resistance.

### CROSS REFERENCE TO RELATED APPLICATIONS

Referring to U.S. Pat. No. 2,160,150A, 1937-10-21, Francis A Jimerson, Harold C Reynolds, Impact Wrench. I believe my method and article is patentable because it's a new and useful thereof method to improve efficiency of prior vehicles also a new composition of matter.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING DISC APPENDIX

Not Applicable

### BACKGROUND OF THE INVENTION

The invention relates to an improved mechanism for applying torque within a vehicle's powertrain. More particularly, the invention relates to such a vehicles powertrain utilizing the mechanisms found in Impact Wrench power tools. These types of power tools work by using a anvil member adapted to the work and a rotating hammer member through which the driving force of motor is transmitted to the anvil member. The connecting means between the motor and the hammer is so constructed that the motor will rotate the hammer and anvil so as the work resistance is insufficient to overcome the driving torque. However, when the torsion set up by the work is greater than the driving torque and enough to prevent movement of the anvil by the hammer, this connection is designed to disengage the hammer and the anvil. While the hammer and anvil are disengaged the rotary driving hammer gains kinetic energy which will deliver its additional energy into the anvil upon reengagement thus repeatedly delivering immense torque.

It was surprisingly found that although this type of mechanism has been used for years to deliver high torque output with minimal exertion from a motor by storing energy in a rotating mass, then delivering it suddenly to the output shaft, it has never been designed to be utilized to adapt the use of power means for supplying both intermittent impulses and smooth rotary motion as needed so that they may be applied within a vehicle's powertrain in a most practical manner in order to overcome the vehicles path work resistance.

### BRIEF SUMMARY OF THE INVENTION

It is still a further object to provide a vehicles powertrain which is novel, and which will overcome path resistance effectively and efficiently.

While the hammer and the anvil are disengaging, the energy supplied by the motor and or engine is stored in a rotating hammer, and as soon as the accumulator force is increased the stored energy is imparted to cause the hammer to reengage with and suddenly impact against the anvil jaws.

Thus, the stored energy is employed to impart an additional angular velocity to the hammer over that imparted by the motor and or engine during the time that the hammer and anvil are re-engaging and the kinetic energy of the hammer is transformed into work delivered to the anvil. A great many forms of such connections have been proposed, but the connection which will disengage the clutch member completely upon a slight angle of rotation of the motor and or engine.

A effective R.I.P. according to the invention will have the following general effect upon a vehicle: heavier towing capacity; and an improved capability to traverse rough terrain.

### BRIEF DESCRIPTION OF THE SEVERAL VIEWS OF THE DRAWING

In the drawings, wherein similar reference characters denote similar elements throughout the several views:

FIG. 1 is a Sectional side view of the Rotary Impact Powertrain while engaged according to the present invention;

FIG. 2 is a Sectional side view of the Rotary Impact Powertrain while disengaged according to the present invention;

FIG. 3 is a Flow Diagram of the Rotary Impact Powertrain mechanism according to the present invention; and

FIG. 4 is a Flow Diagram of the Rotary Impact Powertrain System according to the present invention.

### DETAILED DESCRIPTION OF THE INVENTION

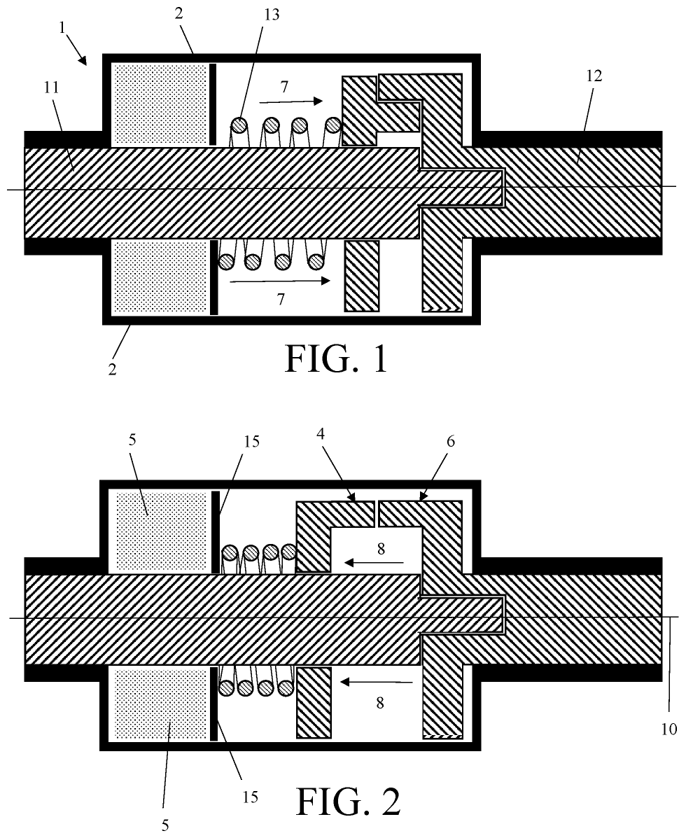

Referring now in detail to the drawings and, in particular to FIGS. 1-2, there is illustrated a mechanism of a Rotary Impact Powertrain 1 (R.I.P.) according to the present invention. This R.I.P. 1 is a simplified example for illustrating the embodiment of the present invention, for of applying a mechanism for supplying both intermittent impulses and smooth rotary motion as needed so that they may be applied within a vehicle's powertrain. The R.I.P. 1 is made from, for example, metals like hardened tool steel. The R.I.P. 1 has a housing 2 that encases the mechanism to protects it from debris, keeps it lubricated, getting damaged from being damaged upon contact with outside forces and for holding the mechanism together. Its input axle 11 rotates along said axis 10 is powered by the motor and or engine which has a rotary driving hammer 4 capable of moving along said axle 11 while staying parallel to its input axels 11 set plane. A engageable accumulator also referenced to as a cooperating clutch or actuator which in this example is shown as a hydraulic system comprising of hydraulic fluid 5, pressure plate 15, and spring 13; the purpose of the engageable accumulator is to constantly engage, increase force 7 or decrease force 8 of the hammer 4 of said driving input axle to driven anvil 6 and its respective output axle 12 that rotates along said axis 10 as well and to in. While the mechanism is engaging shown in FIG. 1 its hammer 4 and anvil 6 clamping force 7 can be gradually increased as needed by its engageable accumulator by increasing hydraulic fluid 5 pressure to push the pressure plate 15 into the spring 13. Therein of which the engageable accumulator increased clamping force 7 between hammer 4 and anvil 6 increased the required work resistance from driven axle 12 required to disengage the hammer 4 and anvil 6. As mentioned above while increasing force 7 the hammer 4 and anvil 6 driving force of the rotary driving hammer 4 is delivering harder hits to the anvil 6; While decreasing force 7 the hammer 4 and anvil 6 driving force of the rotary driving hammer 4 is delivering weaker hits to the anvil.

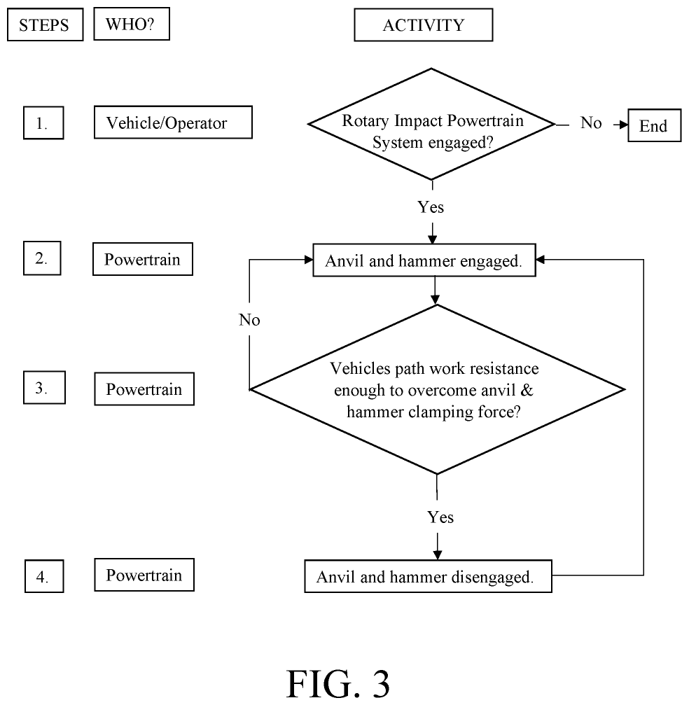

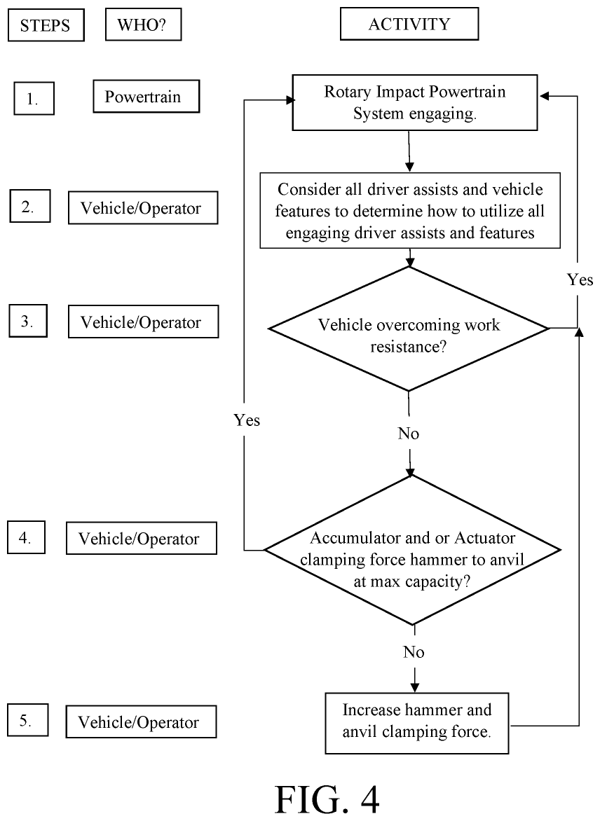

Referring now to a description of the drawings shown in FIG. 3-4. The R.I.P. is engaging only in situations requiring high torque otherwise its ideally is disengaged during normal vehicle operation. While the mechanism is disengaged its hammer 4 and anvil 6 are held in lock by the accumulator by increasing its clamping force 7 of hammer 4 and anvil 6 to max capacity. FIG. 3 is depicting the main process which R.I.P. 1 is executing once engaged. The Operator will engage, or vehicle will engage automatically as needed, for example, in a situation where vehicle operator does not know how to operate the R.I.P. System for best results as depicted in FIG. 4's flow diagram.

While the invention has been described herein with reference to certain preferred embodiments, these embodiments have been presented by way of example only, and not to limit the scope of the invention. Accordingly, the scope of the invention should be defined only in accordance with the claims that follow.

1. A vehicle's powertrain apparatus comprising:
a anvil;
a driven means for the anvil;
a means of connecting the anvil to driven means;
a cooperating clutch on the rotary driving hammer and anvil;
a rotary driving hammer for striking the anvil;
a driving means for the rotary driving hammer; and
an means connecting the rotary driving hammer and driving means.

2. A vehicles powertrain apparatus as in claim 1, wherein said cooperating clutch is a engageable accumulator and or a actuator normally holding the clutch members in engagement.

3. A vehicle's powertrain apparatus comprising:
a engage able mechanism that has a anvil and a rotary driving hammer for striking the anvil;
a mechanism whereby to engage when the driving means can drive the rotary driving hammer and anvil; and
a mechanism whereby to disengage when the driving means is incapable of driving the rotary driving hammer and anvil.

4. A vehicle's powertrain apparatus as in claim 3, wherein said mechanism is a engageable accumulator and or a actuator.

5. A method of applying a engageable mechanism for supplying both intermittent impulses and smooth rotary motion as needed so that they may be applied within a vehicle's powertrain, comprising:
constructed that the motor and or engine will rotate the rotary driving hammer and anvil so long as the work resistance is insufficient to overcome the driving torque;
constructed that a accumulator and or actuator is to increase or decrease amount of work resistance required to overcome driving torque; and
constructed that the torsion set up by the work is greater than the driving torque and enough to prevent movement of the anvil by the rotary driving hammer the clutch members are designed to disengage the rotary driving hammer and anvil

6. A system for managing a Rotary Impact Powertrain apparatus in a vehicle, comprising:
Determining whether Rotary Impact Powertrain is engaged.

7. System of claim 6, wherein Rotary Impact Powertrain is engaging, comprising:
considering all driver assists and vehicle features to determine how to utilize all engaging driver assists and features to overcome work resistance;
determining whether vehicle is overcoming work resistance;
determining whether accumulator and or actuator clamping force of hammer to Anvil is at max capacity; and
Increase hammer and anvil clamping force.
